(19) United States
(12) Patent Application Publication
(10) Pub. No.: US 2018/0355187 A1
(43) Pub. Date: Dec. 13, 2018

(54) LASER MARKING COMPOSITIONS AND METHODS OF MAKING AND USING THE SAME

(71) Applicant: VV Materials LLC, Austin, TX (US)

(72) Inventors: Ryan Richard Huddleston, Austin, TX (US); Robert Kaus, Austin, TX (US)

(21) Appl. No.: 16/004,161

(22) Filed: Jun. 8, 2018

Related U.S. Application Data
(60) Provisional application No. 62/603,640, filed on Jun. 8, 2017.

(51) Int. Cl. C09D 5/33; C09D 1/00; B23K 26/00; B23K 26/322

(52) U.S. Cl. CPC C09D 5/004; B23K 26/322; B23K 26/0006; C09D 1/00

(57) ABSTRACT

Compositions and methods of using and making the same for laser marking substrates such as metal and plastic are disclosed. A marking composition is applied to the surface of the substrate, followed by irradiation of a portion of the marking composition to form a durable marking on the substrate. The non-irradiated portion of the marking composition is then removed from the substrate. The marking compositions described herein can create markings of black, grey, or iridescent, grey markings. The marking composition can comprise silicates, such as hydrated magnesium silicate and be oxide-free. The marking composition can comprise silicates and a combination of bismuth oxide and molybdemum oxide. The marking composition can optionally be combined with a anionic or nonionic surfactant. The compositions and methods of using are useful to create durable marks of high resolution and contrast without damage to the substrate.

### TECHNICAL FIELD

The present disclosure relates to marking compositions and methods for marking and making, which can be useful with commercially available lasers and/or diodes and for marking a substrate, particular those of low porosity.

### BACKGROUND

Laser marking is a marking technique that uses lasers and other forms of radiant energy to bond an additive marking substance to a wide range of substrates. Laser marking forms permanent marks on metals, glass and ceramic parts and is used in many applications, ranging from aerospace to awards and engraving industries. Laser marking differs from the more widely known techniques of laser engraving and laser ablation in that laser marking is an additive process, adding material to the substrate to form the marking instead of removing material as in those techniques.

For metal substrates, parts can be permanently marked with high contrast, high resolution marks for logos, bar-coding, and identification and serialization purposes without damage to the substrate.

Although satisfactory in many regards, a need remains for marks that are permanent and exhibit varying contrast. In addition, for marks subjected to surface wear, abrasion or exposure to environmental factors, it would also be beneficial to improve bonding between the mark and the underlying substrate to prevent or reduce the potential for wearing or removal of the mark. Furthermore, certain marking compositions after being applied in liquid form may dry and dust off of the substrate prior to laser marking. Accordingly, in view of these and other concerns, a need exists for improved marking compositions and methods using such materials.

### SUMMARY

Embodiments described herein pertain to marking compositions and methods that facilitate formation of durable marks of varying contrast, dark marks, and/or shimmery marks on a substrate. Marking compositions described herein can facilitate even application to the substrate, improve durability of the durable mark, and/or improve adhesion of the composition to the substrate prior to forming the durable marking.

One aspect of the present disclosure relates to a method to apply a durable marking to a substrate that comprises applying a marking composition to a substrate, wherein the marking composition comprises a dry weight percentage of hydrated magnesium silicate of at least 95% and does not comprise a metal oxide; impinging the substrate and the composition applied to the substrate with a beam to form a durable marking; and removing a portion of the composition applied to the substrate that was not impinged by the beam, such as by cleaning, wiping, or washing the substrate. In some embodiment, the composition can further comprise a carrier.

Another aspect of the present disclosure relates to compositions for applying a durable marking to a substrate that comprise a dry weight percentage of magnesium silicate of at least 95% and does not comprise a metal oxide. In some embodiment, the composition can further comprise a carrier.

Yet another aspect of the present disclosure is a method of making a composition comprising mixing a magnesium silicate, a nonionic surfactant, and a carrier to form a marking composition that does not comprise a metal oxide. In some embodiment, the composition can further comprise a carrier.

Other aspects of the present disclosure relates to a method to apply a durable marking to a substrate that comprises applying a composition to a substrate, wherein the composition comprises bismuth (III) oxide; molybdenum (VI) oxide; an aluminum silicate; impinging the substrate and the composition applied to the substrate with a beam; and removing a portion of the composition applied to the substrate that was not impinged by the beam, such as by cleaning, wiping, or washing the substrate. In some embodiment, the composition can further comprise a carrier.

Another aspect of the present disclosure relates to compositions for applying a durable marking to a substrate that comprise bismuth (III) oxide; molybdenum (VI) oxide; and an aluminum silicate. In some embodiment, the composition can further comprise a carrier.

Yet another aspect of the present disclosure is a method of making a composition comprising mixing bismuth (III) oxide; molybdenum (VI) oxide; and an aluminum silicate to form a marking composition. In some embodiment, the composition can further comprise a carrier.

Other aspects of the present disclosure relates to a method to apply a durable marking to a substrate that comprises applying a composition to a substrate, wherein the composition comprises an anionic surfactant comprising one or more counter-ions selected from sodium, potassium, magnesium and calcium at a dry weight percentage of 2 to 10%, one or more silicate minerals at a dry weight percentage of 10 to 60%, and one or more metals oxides at a dry weight percentage of 50 to 75%; impinging the substrate and the composition applied to the substrate with a beam; and removing a portion of the composition applied to the substrate that was not impinged by the beam, such as by cleaning, wiping, or washing the substrate. In some embodiment, the composition can further comprise a carrier.

Another aspect of the present disclosure relates to compositions for applying a durable marking to a substrate that comprise an anionic surfactant comprising one or more counter-ions selected from sodium, potassium, magnesium and calcium at a dry weight percentage of 2 to 10%, one or more silicate minerals at a dry weight percentage of 10 to 60%, and one or more metals oxides at a dry weight percentage of 50 to 75%. In some embodiment, the composition can further comprise a carrier.

Yet another aspect of the present disclosure is a method of making a composition comprising mixing an anionic surfactant comprising one or more counter-ions selected from sodium, potassium, magnesium and calcium at a dry weight percentage of 2 to 10%, one or more silicate minerals at a dry weight percentage of 10 to 60%, and one or more metals oxides at a dry weight percentage of 50 to 75% with a carrier. In some embodiment, the composition can further comprise a carrier.

These and other aspects, objects, features, and embodiments will be apparent from the following description and the appended claims.

### BRIEF DESCRIPTION OF THE DRAWINGS

The drawings illustrate only example embodiments of a process for marking a substrate and are therefore not to be considered limiting of its scope.

FIGS. 1A to 1C are schematic cross-section views of a substrate, illustrating a laser marking method in accordance with an embodiment of the present disclosure.

FIGS. 2A to 2C are partially schematic sectional views of a substrate, illustrating a laser marking method in accordance with another embodiment of the present invention.

### DETAILED DESCRIPTION OF EXAMPLE EMBODIMENTS

The marking compositions and methods of the present disclosure facilitate formation of marks of varying contrast or dark marks on a substrate. Contrast marks or dark marks, for the purposes of this disclosure, means marks that are visible to the human eye, and/or machine readable, and are contrasted from the surrounding substrate. For example, a high-contrast or dark mark may appear on a transparent substrate to be a black, silver, grey, brown, purple, blue, green or other high-contrast, dark or colored mark. Compositions can also facilitate formation of marks that have some shimmer or sparkle that is discernable to the human eye in contrast to the surrounding substrate.

As used herein, the term “marking composition” means a compound that can be disposed on a substrate and provide a contrasting mark on the substrate after the region has been irradiated by a laser. The resultant marked region contrasts with the non-irradiated region of the substrate, e.g., the marking may have a different luminance/lightness value and/or color value on the Hunter Lab scale as compared with the non-irradiated region.

In the Hunter Lab scale, also CIELAB scale (so named for the variables L, a, and b), L measures luminance or lightness and varies from 100 for perfect white to zero for black, approximately as the eye would evaluate it. Where DL=L (sample)−L (standard). If DL (which can also be expressed as ΔL) is positive, the sample is lighter than the standard. If DL is negative, the sample is darker than the standard.

The chromaticity dimensions (a and b) give understandable designations of color. The “a” dimension measures redness when positive, grey when zero, and greenness when negative. Where Da=a (sample)−a (standard). If Da (or Δa) is positive, the sample is redder than the standard. If Da is negative, the sample is greener than the standard.

The “b” dimension measures yellowness when positive, grey when zero, and blueness when negative. Where Db=b (sample)−b (standard). If Db (or Δb) is positive, the sample is yellower than the standard. If Db is negative, the sample is bluer than the standard.

The Hunter total color difference (DE or ΔE) for any illuminant or observer is calculated as ΔE=√(ΔL²+Δa²+Δb²).

In some embodiments, the marking composition provides durable markings having different lightness values (L) as compared with the substrate lightness value (L), providing a lightness value difference ΔL between that of the substrate and that of the irradiated marking composition as determined by the standard CIELAB scale. In some embodiments, the marking compositions provide durable markings having different color values (a and b) as compared to the substrate. In some embodiments, the marking compositions provide durable markings having different Hunter total color difference (E) as compared to the substrate.

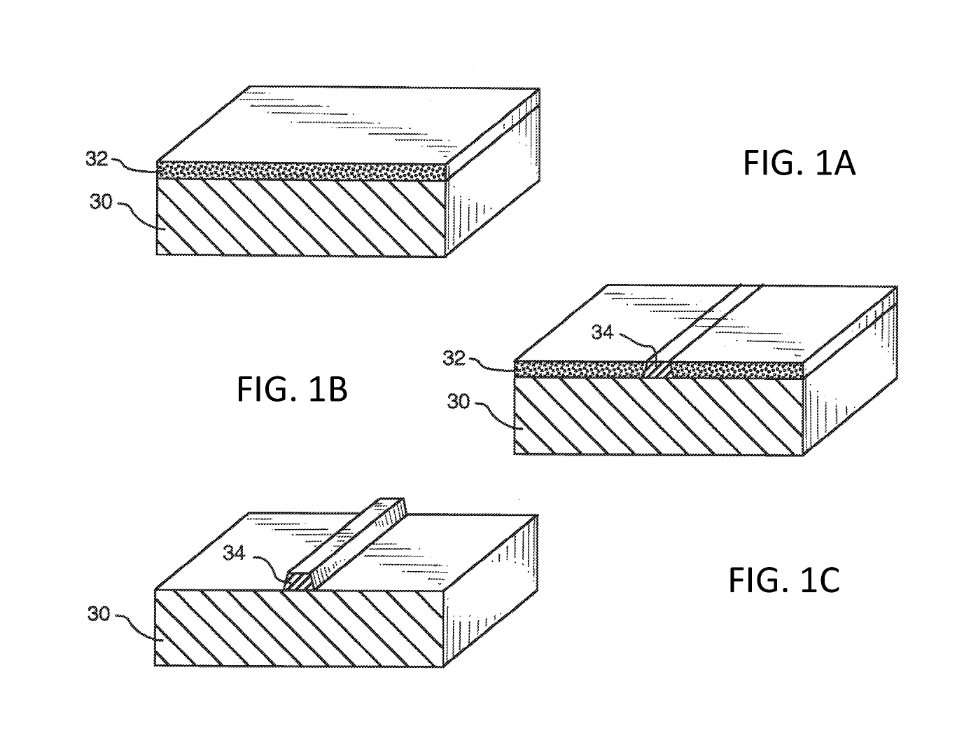

FIGS. 1A to 1C illustrate a laser marking method in accordance with an embodiment of the present disclosure which can be used with any one of the marking compositions described herein. In FIG. 1A, a substrate 30 has a layer of marking composition 32 applied thereto. FIG. 1B illustrates the substrate 30 and marking composition 32 after a portion of the marking composition 32 has been irradiated by a laser (not shown) which travels across and projects a beam roughly perpendicular to the upper surface of the layer of marking composition 32. The irradiated portion 34 is adhered to the surface of the substrate 30 and forms a durable marking thereon. In FIG. 1C, the non-irradiated portion of the marking composition 32 has been washed off, leaving the irradiated marking 34 on the substrate 30.

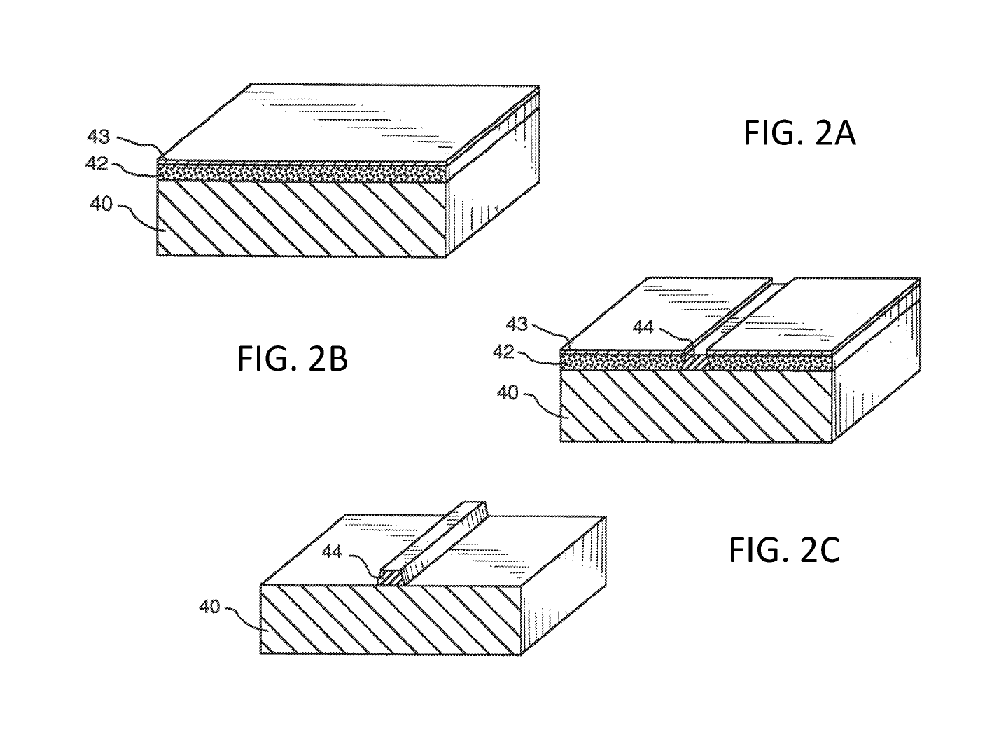

FIGS. 2A to 2C illustrate a laser marking method in accordance with another embodiment of the present disclosure which can be used with any one of the marking compositions described herein. In FIG. 2A, a layer of marking composition 42 is adhered to an adhesive sheet of backing material 43. The backing material may comprise paper, plastic film or the like. The layer of marking composition 42 and backing material 43 are applied to the substrate 40. FIG. 2B illustrates the substrate 40, marking composition 42 and backing material 43 after a portion of the marking composition 42 has been irradiated by a laser (not shown) which travels across and projects a beam perpendicular to the surface of the layer of marking composition 42 to form an irradiated portion 44. The irradiated portion 44 is adhered to the surface of the substrate 40 and forms a durable marking thereon. In FIG. 2C, the non-irradiated portion of the marking composition 42 has been removed by peeling the backing material 43 and non-irradiated marking composition 42 away from the substrate 40. The irradiated marking 44 remains adhered to the substrate 40 to form a durable marking.

In accordance with the present disclosure, a substrate can be comprised of metal. Suitable metal substrates include steel (e.g., stainless steel), chrome, gold or gold-plating, brass, bronze, aluminum, tin, and zinc. In some embodiments, the metal is not silver.

Articles that may be marked in accordance with the present invention include consumer products, containers (e.g., stainless steel tumblers and coozies), automotive parts, aerospace parts, medical devices, electronic devices, tools, packaging, metal tags, bricks, plumbing, electrical and construction supplies, and the like.

In accordance with the present disclosure, a marking composition as described here is applied to the surface of the substrate, such as to form a coating or layer on the substrate.

The layer of marking composition is typically applied to the substrate with a thickness of at least about 0.1 micron, preferably from about 1 to about 300 microns, more preferably from about 5 to about 200 microns, and most preferably from about 10 to about 100 microns.

Various methods may be used to apply the marking composition to the substrate. The marking composition which comprises a metal oxide and/or silicate dispersed in a carrier can be applied onto the substrate by various methods such as brush, dosing, deposition, dispensing, coating, metering, painting, spraying (such as with an air brush or aerosol), pad printing, screen printing, roll coating, and others. The amount of carrier in the marking composition can be adjusted based on the application technique being used.

Alternatively, a temporary substrate can be used to transfer the composition to the surface intended for the durable marking. A layer of composition can be disposed on a surface the temporary substrate, such as a tape and/or label. The temporary substrate facilitates transfer to the surface intended for the durable marking. The tape can be a thin film material. The tape can be transparent, opaque, or translucent. The label and tape fabrication promote proper and substantially uniform average thickness of the marking composition onto the surface intended for durable marking. Suitable temporary substrates for this type of application technique are, for example, paper and flexible plastic films such as polyester, polyethylene, and polypropylene films. It is not necessary that a tape or adhesive-carrying film be used. It is also contemplated that nearly any single or multiple film could be used as a temporary substrate for a marking composition so long as the film does not interfere with the marking composition upon application to the substrate of interest, and laser energy can penetrate the thickness of the film to reach the marking composition and cause marking on the substrate of interest. A composition as described herein may include a binder to facilitate application to a temporary substrate.

After the marking composition is applied to the surface of the substrate, a selected portion of the marking composition is irradiated with a beam to adhere the irradiated marking composition to the substrate and to form a durable marking thereon. A laser is preferably used to selectively irradiate the marking composition. However, other forms of focused energy may be used in accordance with the present disclosure. Irradiation may be achieved by moving a laser beam over a stationary substrate using conventional beam steering methods, by moving the substrate in relation to the laser beam and/or by masking the substrate. Laser irradiation is typically achieved by impinging the substrate and the marking composition thereon with the beam.

The beam emanating from the radiant energy source lasers the marking composition, which absorbs the radiant energy and increases to the required temperature. In absorbing the radiant energy, at least a portion of the marking composition is excited, i.e. has its atoms or molecules raised to an excited state. Typically, a temperature of 200° to 1500° F. is reached in approximately one to two microseconds. Precise temperatures are controlled by the output power of the radiant energy source and the physical position of the marking material relative to the focal plane of the radiant energy beam and the speed with which the beam is moving. Once the required temperature is achieved, the marking composition will durably bond with the substrate to form a laser mark on the substrate. Suitable lasers for use in accordance with the present invention include fiber lasers, neodymium:yttrium aluminum garnet (Nd:YAG) lasers, carbon dioxide (CO₂) lasers, diode lasers, excimer lasers and the like.

Typical fiber laser is a laser in which the active gain medium is an optical fiber doped with rare-earth elements such as erbium, ytterbium, neodymium, dysprosium, praseodymium, and thulium. They are related to doped fiber amplifiers, which provide light amplification without lasing. Fiber lasers are also commercially available from numerous sources. A suitable fiber laser for use in the present laser marking methods is a 10 watt non-pulsed fiber laser with about 904 nm to about 1065 nm wavelength.

Typical CO₂ lasers produces a beam of infrared light with the principal wavelength bands centering around 9.4 and 10.6 micrometers. CO₂ lasers are available commercially from numerous sources. One suitable CO₂ laser is a 35 watt CO₂ laser with about 9.2 micron to about 11.4 micron wavelength. Typical settings for a 35 watt CO₂ laser for universal laser markings is from about 50% to about 100% of full power at speeds from about 5 to about 100 inches per second.

Typical YAG lasers emit light in the near-infrared spectrum at wavelengths of 1064 nm. Such lasers typically have continuous power outputs of from about 1 to about 50 watts, and can be operated in a pulsed mode at typical peak powers of from about I watt to about 45 kilowatts. For pulsed mode operation, frequencies of from about 1 to about 64,000 pulses/second may be used.

Generally, the intensity of the laser and the particular wavelength or ranges of wavelength(s) are selected based upon the characteristics of the composition and the surface to be laser marked. The term “speed” as used herein refers to the velocity of the marking head as it moves across the surface being lased. The marking conditions will vary from one laser to another and achieving a mark is not limited to a particular laser. Changing to a higher or lower wattage laser would change the marking parameters, so one could mark at a lower % power and faster speed or vise versa.

In accordance with the present invention, the size of the laser spot that impinges the marking composition is typically greater than 0.1 micron in diameter, preferably from about 40 to about 500 microns, and more preferably from about 50 to about 125 microns. The speed at which the laser beam travels across the surface of the marking composition preferably ranges from 0 to about 100 inches/second (up to about 250 cm/second), more preferably from about 1 or 2 to about 20 inches/second (about 2.5 or 5 to 50 cm/second) for most thicknesses and compositions of marking composition. The laser beam may be projected with a seam overlap of 0 to 100 percent, preferably from about 10 to about 90 percent for many applications. The laser parameters are controlled in order to provide sufficient localized heating of the marking composition while avoiding unwanted damage to the substrate.

Laser marking is typically performed with the beam in focus, but may also be carried out with the beam out of focus. Lamp currents of from about 28.5 to about 30 amps and writing speeds of from about 2 to about 5 inches/second (about 5 to 12.7 cm/second) are particularly advantageous for many applications.

The laser beam, the movement of which can be controlled by a computer, may be used to create discrete symbols or designs or, alternatively, may be serially indexed across the surface of the marking composition to create multiple symbols or designs at the same time. For example, a word may be created by separately making each letter of the word with the laser, or by rastering the laser across the entire word to form all of the letters at the same time.

In accordance with the present invention, a selected portion of the marking composition is durably adhered to the substrate upon irradiation. As used herein, the term “adhere” is used to designate any durable mode of attachment of the irradiated marking composition to the substrate. For example, the irradiated marking material may be adhered to the surface of the substrate using the laser, wherein the laser irradiation sinters the marking material to the substrate, fuses the marking material to the surface of the substrate, diffuses at least a portion of the marking material into the substrate, causes a chemical or physical reaction in the marking material or between the marking material and the substrate, or the like. As used herein, the term “durable marking” means a non-temporary marking that is unaffected by normal use of the article to which the durable marking is applied or a marking that is substantially as durable as the substrate. Durable markings resulting from the compositions and methods herein possesses relatively high wear resistance, corrosion resistance and/or fading resistance.

In the marking methods, mark quality depends on a variety of factors, including the substrate used, marking speed, laser spot size, beam overlap, marking material thickness, and laser parameters.

The durable markings produced in accordance with the present disclosure preferably have a thickness of from 0 to about 100 microns as measured from the surface of the substrate, preferably from about 0.05 to about 30 microns.

After the selected portion of the marking composition has been irradiated, the non-irradiated portion of the marking composition is removed from the substrate. Removal of non-irradiated marking composition is accomplished depending on the form and application technique employed to deliver and apply the marking composition. In the embodiment shown in FIGS. 1A to 1C, the non-irradiated portion of the marking composition may be removed by conventional cleaning processes. Such processes can involve rinsing, wiping, brushing off, vacuuming, subliming or blowing off the surface. In the embodiment shown in FIGS. 1A to 1C, the non-irradiated portion of the marking composition remains adhered to the adhesive sheet 43, and may be removed from the substrate 40 by peeling the adhesive sheet and non-irradiated layer away from the substrate. The unused marking composition can be recovered from the cleaning process and reused.

Various types of marks may be produced in accordance with the present invention. For example, the marks may comprise alphanumeric symbols, graphics, logos, designs, decorations, serializations, bar codes, two dimensional matrices and the like. Furthermore, by using conventional laser controlled hardware and software, the markings of the present invention may be quickly varied from operation to operation for applications such as serialization, bars codes, manufacturing quality control and automated manufacturing.

### Marking Compositions

The marking compositions described herein comprise an absorber as described below, a carrier, and optional additives.

Absorber, as used herein, refers to a component of the marking composition that absorbs radiant energy and bonds and/or fuses with the substrate to form a mark having a luminance, color value, or degrees of opacity that provide visual contrast with the substrate.

A carrier can be incorporated for transferring the absorber particles. The carrier can comprise water or other aqueous-based liquids and/or one or more organic solvents (e.g., water miscible volatile solvents). If water is selected as the carrier, the water can be purified water. Examples of purified water include but are not limited to distilled water and de-ionized (DI) water. Non-limiting examples of organic solvents include alcohols such as ethanol. Non-limiting examples of organic solvents also includes ketones, alkanes such as butane (such as if in liquid form as a result of pressurization such as may be used for spray applications), and aromatic organic solvents such as xylenes.

In accordance with the present disclosure, the marking compositions may include carriers such as water, alcohols, polyols, chlorinated solvents, amines, esters, glycol ethers, ketones, terpenes, petroleum naphthas, aromatic hydrocarbons and natural oils. Other suitable carriers include furans, isoparaffins, N,N dimethylformamide, dimethylsulfoxide and tributylphosphine.

A first marking composition in accordance with the present disclosure can comprise as an absorber, magnesium silicate. The first composition when applied to a substrate can result in a durable marking that is grey, silver, or silver grey. There can be some white or substantially white light reflection giving the durable marking the silver-metallic color or finish. For example, in some embodiments, the marking composition comprise a dry weight percentage of magnesium silicate of at least 90% or at least 95% and does not comprise a metal oxide. (As used herein, “dry weight percentage” means the weight percentage of a component in a marking composition relative to the total weight of all components of a marking composition except for the carrier.) In some embodiments, the first marking composition comprises or consists of magnesium silicate, a nonionic surfactant, and an organic solvent carrier, such as ethanol.

In some embodiments, the first marking composition comprises talc as the source of the magnesium silicate. In some embodiments, the magnesium silicate is hydrated magnesium silicate. In some embodiments, the dry weight percentage of hydrated magnesium silicate is greater than 90% or greater than 93% or greater than 95%. In some embodiments, the dry weight percentage of hydrated magnesium silicate is between 90% and 98% or between 95% and 98%.

In some embodiments, the first marking composition further comprises a nonionic surfactant and more specifically a nonionic, metal-free surfactant. The nonionic surfactant facilitates dispersion of the particulate components (e.g., the magnesium silicate) and volatilizes after laser impigment leaving very little or an insignificant amount of residue. The nonionic surfactant can be a polymerized, non-functionalized glycol such as polyethylene glycol and/or polypropylene glycol. In some embodiments, the first marking composition comprises a dry weight percentage of polyethylene glycol or polypropylene glycol of less than 10% or less than 7% or less than 6% or less than 3%. In some embodiments, the dry weight percentage of polyethylene glycol or polypropylene glycol is 4% to 6%.

A second marking composition in accordance with the present disclosure can comprise as an absorber, bismuth (III) oxide, molybdenum (VI) oxide, and aluminum silicate. The second composition when applied to a substrate can result in a durable marking that is grey or silver and iridescent, shimmery and/or sparkling. The durable marking is refractive in that at least a portion of the light striking the marking is refracted to give a slight iridescent effect. In some embodiments, the second marking composition comprises or consists of bismuth (III) oxide, molybdenum (VI) oxide, aluminum silicate, and a carrier.

In addition to being an absorber, the aluminum silicate of the second composition facilitates adhesion of the marking to the substrate. As such, in some embodiments, no additives are needed to facilitate adhesion. In some embodiments, the second marking composition comprises kaolin as the source of the aluminum silicate. In some embodiments, the aluminum silicate is hydrated aluminum silicate.

In some embodiments, the marking composition can comprise a dry weight percentage of (i) bismuth (III) oxide that is 30% to 65% or 30% to 40% or 40% to 50% or 50% to 60% or 60% to 65%; (ii) molybdenum (VI) oxide that is 0.5% to 5% or 0.5% to 1.5% or 2% to 3% or 3% to 4% or 4% to 5%; and (iii) hydrated aluminum silicate that is 30% to 70% or 30% to 40% or 40% to 50% or 50% to 60% or 60% to 70%. In some embodiments, the dry weight percentage of (i) bismuth (III) oxide is 45% to 55%; (ii) molybdenum (VI) oxide that 1% to 5%; and (iii) hydrated aluminum silicate that is 45% to 50%.

A third marking composition in accordance with the present disclosure can comprise as an absorber, molybdenum (VI) oxide, an anionic surfactant(s), and silicate mineral(s). The second composition when applied to a substrate can result in a durable marking that is black or near black. In some embodiments, the second marking composition comprises or consists of molybdenum (VI) oxide, an anionic surfactant(s), silicate mineral(s), and a carrier.

The third marking composition can comprise an anionic surfactant at a dry weight percentage of 2 to 10%, one or more silicate minerals at a dry weight percentage of 10 to 60%, and molybdemum oxide at a dry weight percentage of 50 to 75%. In some embodiments, the molydumum (VI) oxide is at a dry weight percentage of 60 to 70%.

In addition to being an absorber, the anionic surfactant facilitates dispersion of the particulate components (e.g., molybdemum oxide and the silicate minerals), application of the composition, and also gives the marking composition a dried consistency that is slightly waxy or tacky, which improves adherence of the marking composition to the substrate prior to irradiation. In particular, the anionic surfactant minimizes the rate of or prevents the occurrence of clogging of an airbrush or aerosol nozzle. In some embodiments, the anionic surfactant is a sulfate-based surfactant, such as an aliphatic or derivativized aliphatic sulfate-based surfactant, or more specifically, an ether-containing sulfate-based surfactant. In some embodiments, the anionic surfactant comprises laureth sulfate and/or lauryl sulfate and one or more counter-ions selected from sodium, potassium, magnesium and calcium. In some embodiments, the anionic surfactant is sodium laureth sulfate. In some embodiments, the third marking composition comprises an anionic surfactant at a dry weight percentage between 2% to 10%, such as 2 to 4%; 4% to 6%; 6% to 8%; or 8% to 10%. In some embodiments, the third marking composition comprises an anionic surfactant at a dry weight percentage between 3% to 7%.

In some embodiments, the one or more silicate minerals of the third marking composition are selected from aluminum silicate and magnesium silicate. In addition to being an absorber, the aluminum silicate facilitates adhesion of the marking to the substrate and magnesium silicate in the form of a fine powder facilitates a more uniformly dispersed composition and a more even application of the composition to the substrate. In some embodiments, the one or more silicate minerals are aluminum silicate and magnesium silicate. In some embodiments, the one or more silicate minerals are hydrated aluminum silicate and hydrated magnesium silicate. Talc can be the source of the magnesium silicate, and kaolin can be the source of the aluminum silicate. In some embodiments, the third marking composition comprises a hydrated magnesium silicate at a dry weight percentage between 0% to 30% or 5% to 10% or 10% to 20% or 20% to 30%. In some embodiments, the third marking composition comprises a hydrated magnesium silicate at a dry weight percentage between 10% to 25% or 15% to 25%. In some embodiments, the third marking composition comprises a hydrated aluminum silicate at a dry weight percentage between 10% to 40% or 10% to 20% or 20% to 30% or 30% to 40%. In some embodiments, the third marking composition comprises a hydrated aluminum silicate at a dry weight percentage between 10% to 20%. In some embodiments, the third marking composition comprises or consists of molybdenum (VI) oxide, sodium laureth sulfate, aluminum silicate, and a carrier within the dry weight percentage ranges set forth above. In some embodiments, the third marking composition comprises or consists of molybdenum (VI) oxide, sodium laureth sulfate, magnesium silicate, aluminum silicate, and a carrier within the dry weight percentage ranges set forth above.

### Additional Components

The marking compositions of the present disclosure unless indicated otherwise may optionally comprise an amount of binder materials to improve rheological properties, green strength, or package stability for the compositions. Binders may include epoxies, polyesters, acrylics, methacrylics, cellulosics, vinyls, natural proteins, styrenes, alkyl sulfates, polyalkyls, carbonates, rosins, rosin esters, alkyls, drying oils, and polysaccharides such as starches, guar, dextrins and alginates, and the like.

The marking compositions may optionally include other additives to improve various characteristics of the marking compositions either before or after lasing. For example, additives can be added to improve bonding, dispersability, wetting, flow, rheology and the appearance of the mark. Additives can also be added to relieve surface defects and thermal stresses of the mark

Marking compositions can incorporate these additional components depending on the intended application. Non-limiting examples of typical additives include coloring agents, viscosity adjusting agents, thermal expansion modifiers, flow controllers, stabilizers, co-solvents such as alcohols, and clarity promoters to promote maintenance of optical characteristics of the marking compositions. As noted, the use of one or more additives in the marking composition(s) is optional.

Preparation of the marking composition in liquid form can, for example, occur through low shear mechanical mixing, high shear mechanical mixing, ultrasonic mixing and/or milling, or the like.

The following examples are meant to be illustrative and not limiting.

### EXAMPLE 1

### Silver Contrasted Marking Material

The following material is prepared using a three component mixture of the clay mineral composed of hydrated magnesium silicate with a chemical formula of H₂Mg₃(SiO₃)₄ or Mg₃Si₄O₁₀(OH)₂, polyethylene glycol and the appropriate amount of solvent to produce a suspension that can be applied with an airbrush, brush or other application techniques known to the art.

A 10 kg illustrative example of the preparation is as follows: Add 6 L of anhydrous reagent grade ethanol to a 10 L mechanically stirred three-neck flask at room temperature. Add 250 grams of polyethylene glycol to the ethanol and stir for 1 hour at room temperature. With vigorous stirring add 5 kg of H₂Mg₃(SiO₃)₄. Stir for 12 hours at room temperature, after which time the mixture is ready for application to the appropriate substrate. The mixture can be applied with an airbrush, brush or other application techniques known to the art.

### EXAMPLE 2

### Shimmery or Sparkly Grey Contrast Marking Material

The following material is prepared using a four component mixture of the clay mineral composed of hydrated aluminum silicate with a chemical formula of Al₂Si₂O₅(OH)₄, Molybdenum (VI) Oxide, Bismuth (III) Oxide and the appropriate amount of solvent to produce a suspension that can be applied with an airbrush, brush or other application techniques known to the art.

A 7.9 kg illustrative example of the preparation is as follows: Add 5 L of anhydrous reagent grade ethanol to a 10 L mechanically stirred three-neck flask at room temperature. Add 120 g of Molybdenum (VI) Oxide to the ethanol and stir for 1 hour at room temperature. Add 1.8 kg of Al₂Si₂O₅(OH)₄ to the ethanol and stir for 1 hour at room temperature. Add 2.0 kg of Bismuth(III) Oxide to the ethanol and stir for 1 hour at room temperature. Stir for 12 hours at room temperature, after which time the mixture is ready for application to the appropriate substrate. The mixture can be applied with an airbrush, brush or other application techniques known to the art.

### EXAMPLE 3

### Black Contrast Marking Material

The following material is prepared using a five component mixture of the clay mineral composed of hydrated aluminum silicate with a chemical formula of Al₂Si₂O₅(OH)₄, Molybdenum (VI) Oxide, H₂Mg₃(SiO₃)₄, sodium laureth sulfate and the appropriate amount of solvent to produce a suspension that can be applied with an airbrush, brush or other application techniques known to the art.

A 8.5 kg illustrative example of the preparation is as follows: Add 3.5 L of anhydrous reagent grade ethanol to a 10 L mechanically stirred three-neck flask at room temperature. Add 3.25 kg of Molybdenum (VI) Oxide to the ethanol and stir for 1 hour at room temperature. Add 1 kg of H₂Mg₃(SiO₃)₄ to the ethanol and stir for 30 min at room temperature. Add 750 g of Al₂Si₂O₅(OH)₄ to the ethanol and stir for 30 min at room temperature. In a separate flask, dissolve 268 g of sodium laureth sulfate in 450 ml of water and then add to the previous ethanol mixture over 10 minutes with vigorous stirring. Stir for 12 hours at room temperature, after which time the mixture is ready for application to the appropriate substrate. The mixture can be applied with an airbrush, aerosol, brush or other application techniques known to the art.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

1. A method to apply a durable marking to a substrate comprising applying a composition to a substrate, wherein the composition comprises bismuth (III) oxide; molybdenum (VI) oxide; aluminum silicate; and
a carrier; and
impinging the substrate and the composition applied to the substrate with a beam.

2. The method of claim 1, comprising removing a portion of the composition applied to the substrate that was not impinged by the beam by rinsing, washing, or wiping.

3. The method of claim 1, wherein a dry weight percent of bismuth (III) oxide is 45% to 65%.

4. The method of claim 3, wherein a dry weight percent of molybdenum (VI) oxide is 1% to 5%.

5. The method of claim 4, wherein aluminum silicate is a hydrated aluminum silicate with a dry weight percent of 30% to 60%.

6. The method of claim 5, wherein the substrate is metal.

7. The method of claim 1, wherein the beam is a fiber laser beam or a CO2 laser beam or a Nd:YAG laser beam.

8. The method of claim 1, wherein the durable marking is a grey or silver durable marking.

9. The method of claim 1, wherein the durable marking is a shimmery marking or wherein the durable marking refracts at least a portion of light impinging the durable marking or wherein the durable marking reflects a substantial portion of a full visible light spectrum when visible light impinges the durable marking.

10. A marking composition for applying a durable marking to a substrate, the composition comprising bismuth (III) oxide and molybdenum (VI) oxide; aluminum silicate; and a carrier, wherein the composition is configured to form the durable marking on the substrate when irradiated with a beam.

11. The composition of claim 10, wherein the composition is configured to be removed from the substrate if not irradiated by the beam by rinsing, washing, or wiping.

12. The composition of claim 10, wherein a dry weight percent of bismuth (III) oxide is 45% to 65%.

13. The composition of claim 12, wherein a dry weight percent of molybdenum (VI) oxide is 1% to 5% and wherein aluminum silicate is a hydrated aluminum silicate with a dry weight percent of 30% to 60%.

14. (canceled)

15. The composition of claim 14, wherein the substrate is metal, such as stainless steel or aluminum.

16. (canceled)

17. (canceled)

18. The composition of claim 10, wherein the durable marking is a grey or silver durable marking or wherein the durable marking is a shimmery marking, refracts at least a portion of light impinging the durable marking, or reflects a substantial portion of a full visible light spectrum when visible light impinges the durable marking.

19. A method of making a marking composition, the method comprising mixing bismuth (III) oxide, molybdenum (VI) oxide; aluminum silicate; and a carrier, wherein the composition is configured to form the durable marking on the substrate when irradiated with a beam.

20. The method of claim 19, wherein the composition is configured to be removed from the substrate if not irradiated by the beam by rinsing, washing, or wiping.

21. The method of claim 19, wherein a dry weight percent of bismuth (III) oxide is 45% to 65%.

22. The method of claim 21, wherein a dry weight percent of molybdenum (VI) oxide is 1% to 5% and wherein aluminum silicate is a hydrated aluminum silicate with a dry weight percent of 30% to 60%.

23. (canceled)

24. (canceled)

25. (canceled)

26. (canceled)

27. The method of claim 19, wherein the durable marking is a grey or silver durable marking or wherein the durable marking is a shimmery marking or wherein the durable marking refracts at least a portion of light impinging the durable marking or wherein the durable marking reflects a substantial portion of a full visible light spectrum when visible light impinges the durable marking.

28-84. (canceled)
